(19) United States
(12) Patent Application Publication
(10) Pub. No.: US 2020/0054972 A1
(43) Pub. Date: Feb. 20, 2020

(54) FILTER ASSEMBLY WITH FILTER LOCK DESIGN

(71) Applicants: Andrew BRYCE, Visp (CH); Lonza Ltd., Visp (CH)

(72) Inventor: Andrew BRYCE, Dover, NH (US)

(21) Appl. No.: 16/345,963

(22) PCT Filed: Nov. 15, 2017
(86) PCT No.: PCT/US2017/061736

§ 371 Date: Apr. 29, 2019

Related U.S. Application Data
(60) Provisional application No. 62/423,526, filed on Nov. 17, 2016.

(51) Int. Cl. B01D 29/15; B01D 29/52

(52) U.S. Cl. CPC B01D 29/15; B01D 35/30; B01D 29/52

(57) ABSTRACT

A filter assembly is used to filter liquids and includes a housing containing a plurality of filter cartridges. The filter cartridges are installed on a base within recesses. The recesses include a tapered first section, a cartridge guiding section that comprises a chamfered surface, and a cartridge engaging section. The different sections of the recess guide one or more gaskets on a filter cartridge into the recess and facilitate formation of a fluid tight seal without causing the gaskets to dislodge or otherwise malfunction.

### RELATED APPLICATION

The present application is based on and claims priority to U.S. Provisional Patent application Ser. No. 62/423,526, filed on Nov. 17, 2016, and which is incorporated herein by reference.

### BACKGROUND

Various different filter assemblies exist for filtering all different types of materials. For example, filter assemblies are used to filter fluids in the pharmaceutical field, in the food service industry, and in the water purity industry. The configuration of the filter assembly can depend upon the fluid being filtered. In general, the filter assembly is designed to receive a fluid and to filter out from the fluid contaminants or waste which may comprise particles or other substances that are dissolved, undissolved or immiscible in the liquid.

In one type of application, the filter assembly includes a plurality of filter cartridges that are attached to a base assembly in a vertical position. A housing or dome is placed over the filter cartridges and a fluid tight seal is formed between the housing or dome and the base assembly. Each filter cartridge can have a tubular shape and can include a filter media encased within the cartridge that is designed to filter out contaminants from the particular fluid being fed through the system.

The filter assembly can further include an inlet and an outlet. A fluid to be filtered is sent through the inlet and into the housing. Once in the housing, the fluid is forced through the filter cartridges. For example, filter assemblies can be designed to operate at various pressures within the housing. The fluid pressure within the housing, for instance, can be greater than about 5 psi, such as greater than about 10 psi, such as greater than about 20 psi. Operating pressures can exceed, in some cases, 1000 psi.

Once forced through the filter cartridges, contaminants contained within the fluid are removed by the filter media and the clean fluid is collected in an outlet.

Over time, the filter cartridges accumulate significant amounts of contaminants and waste. Due to the contaminants and waste, the filter cartridges begin to lose their efficiency. Consequently, the filter cartridges contained within the filter assembly are required to be removed and replaced on a periodic basis.

When the filter cartridges are removed and replaced, it is very important that the new filter cartridges form a fluid tight seal with the base assembly. In order to seal the filter cartridge against the base assembly, in many applications, the filter cartridge includes one or more O-rings positioned at the end of the cartridge that are designed to be seated against a surface of the base assembly. Unfortunately, during replacement of the filter cartridges, problems can occur in correctly installing the cartridges resulting in an improper seal between the cartridge and the base assembly. For example, one problem that has been experienced in the past is that when non-ideal conditions exist, the O-rings have a tendency to become unseated and roll on the cartridge preventing the cartridge from forming a fluid tight seal and/or a sterile seal with the base assembly. Unseated O-rings or gaskets can lead to disastrous consequences. For instance, filter cartridges not properly installed can lead to fluid leaks allowing unfiltered liquid to bypass the cartridges and contaminate the product being produced.

In view of the above, a need exists for an improved filter assembly, and particularly for a system for sealing filter cartridges within a filter assembly.

### SUMMARY

In general, the present disclosure is directed to a filter assembly containing one or more filter cartridges for filtering fluids, such as liquids or gases. More particularly, the present disclosure is directed to a filter cartridge lock and sealing assembly that allows filter cartridges to be easily removed and installed in the system without gasket failure. For example, in one embodiment, the present disclosure is directed to a specially designed recess that includes a plurality of surfaces that work in conjunction to receive an end of a filter cartridge while minimizing gasket errors, such as the occurrence of unseated rolled O-rings.

In one embodiment, for instance, the present disclosure is directed to a drain and locking base for a filter assembly. The base may comprise a base plate that has a perimeter. Located along the perimeter is a securing mechanism for securing the base plate to an open end of a filter housing. In one embodiment, a gasket may also be provided between the filter housing and base plate for producing a fluid tight seal.

The base plate further comprises a plurality of filter receiving recesses that are each configured to receive an end of a filter cartridge. Each recess includes an engaging element for securing a filter cartridge to the base plate. The recess has a depth and includes a first section adjacent to a top end of the recess. The first section has a first diameter and a wall. The wall has a tapering height.

Each recess can further include a gasket guiding section positioned below the first section. The gasket guiding section can comprise a chamfered surface having an angle of from about 30° to about 60° in relation to a vertical line parallel to a central axis of the recess. In other embodiments, the angle of the chamfered surface may be from about 35° to about 55°, such as from about 40° to about 50°. In one embodiment, the chamfered surface is at an angle of about 45°. The chamfered surface can have a length (measured along the same direction as the vertical line) of from about 0.8 mm (0.03 in) to about 3.2 mm (0.15 in), such as from about 1.1 mm (0.04 in) to about 2.6 mm (0.1 in), such as from about 1.3 mm (0.05 in) to about 1.7 mm (0.07 in).

Each recess of the base plate further includes a gasket contacting section adjacent to the gasket guiding section. The gasket contacting section has a second diameter that is less than the first diameter of the first section. The second diameter has a size that engages a gasket on a filter cartridge to form a fluid tight seal when the filter cartridge is inserted into the recess.

As described above, the top end of the first section can have a wall with a tapering height. For example, the difference between a greatest height in the wall and a lowest height in the wall can be from about 0.5 mm (0.01 in) to about 2 mm (0.08 in), such as from about 0.8 mm (0.03 in) to about 1.5 mm (0.06 in). The tapering wall can be at an angle to a horizontal line that is perpendicular to a central axis of the recess of from about 0.5° to about 1.5°.

In one embodiment, the gasket guiding section is adjacent to the first section at one end and adjacent to the gasket contacting section at an opposite end. At the first end the gasket guiding section can have the same diameter as the first section. At the opposite end, on the other hand, the gasket guiding section can have a diameter that is the same as the diameter of the gasket contacting section.

The base plate can further include at least one outlet. Each of the recesses can be in fluid communication with one or more of the outlets for allowing filtered fluids to flow out of the filter assembly.

The present disclosure is also directed to a filter assembly incorporating the base as described above. The filter assembly can include a housing defining a hollow interior and an open end. At least one filter cartridge, such as a plurality of filter cartridges, can be contained within the hollow interior of the housing. Each filter cartridge can include a first end and a second end. The second end of each filter cartridge can include at least one gasket, such as an O-ring, that encircles the cartridge. The second end of each filter cartridge is designed to be inserted into one of the recesses of the base plate.

In one embodiment, each recess in the base plate can include an engaging element for securing the filter cartridge to the base. For example, each filter cartridge may include a plurality of locking elements that can be secured in a corresponding plurality of engaging elements on the base plate. In one particular embodiment, each filter cartridge is twisted into a corresponding recess causing locking elements on the filter cartridge to be inserted into engaging elements or slots within the recess.

The filter cartridges of the present disclosure can be made from various materials. In one embodiment, each filter cartridge includes a filter housing containing a filter media. The filter media can comprise any suitable material depending upon the particular application. For instance, the filter media may comprise a hydrophilic membrane or a hydrophobic membrane. In one embodiment, the filter media may comprise polyvinylidene fluoride. The filter media may have a pore size of less than about 0.5 microns, such as less than about 0.4 microns, such as less than about 0.3 microns, such as less than about 0.25 microns.

The filter assembly further includes at least one fluid inlet and at least one fluid outlet. Fluids entering the inlet are forced through the filter cartridges and a filtered liquid flows through the fluid outlet and is collected.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a side view of one embodiment of a filter assembly made in accordance with the present disclosure;

FIG. 2 is a perspective view of one embodiment a base that may be incorporated into the filter assembly shown in FIG. 1;

FIG. 3 is a perspective view with cut away portions of the base illustrated in FIG. 2;

FIG. 4 is a is a perspective view of one embodiment of a filter cartridge the may be used in the filter assembly of the present disclosure;

FIG. 5 is a is a perspective view of one embodiment of a filter cartridge receiving recess made in accordance with the present disclosure; and

FIG. 6 is a cross-sectional view of the cartridge filter receiving recess as shown in FIG. 5; and

FIG. 7 is a plan view of the cartridge filter receiving recess as shown in FIGS. 5 and 6.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to a filter assembly for filtering fluids, such as liquids and gases. The fluid, for instance, may comprise a solution, a suspension, a dispersion or the like containing contaminants or waste that are to be removed by the filter assembly. The present disclosure is also directed to a base for use in a filter assembly. The base includes at least one filter cartridge receiving recess that is designed to form a fluid tight seal with a filter cartridge. In accordance with the present disclosure, the filter cartridge recess is also designed so that filter cartridges can be removed and replaced quickly and easily while minimizing gasket malfunctions.

During the use of filter assemblies of the type of the present disclosure, the filter cartridges can accumulate significant amounts of contaminants and waste which ultimately can degrade their efficiency and usefulness. Consequently, the filter cartridges must be removed and replaced on a periodic basis. Removal and replacement is preferably done as quickly as possible in order to minimize downtime of the process. Depending upon the fluids being filtered, various different environments can exist within the filter assembly during the replacement of the cartridges. One reoccurring problem that has persisted in filter assemblies is the unseating or other malfunction of the gasket around the filter cartridges during installation, especially during breaks in the filtering process. For instance, many filter cartridges have O-rings that can roll and displace from a groove on the cartridge. When this occurs, the cartridge can malfunction and not form a fluid tight seal within the filter assembly. When this occurs, unfiltered and/or contaminated fluids can combine in the effluent with filtered fluids to produce a contaminated product. Once contamination occurs, the entire product batch needs to be reprocessed and refiltered.

In this regard, the present disclosure is directed to a uniquely designed recess for sealing with filter cartridges. The recess of the present disclosure includes at least three different surfaces that work in conjunction to prevent gasket failure on the filter cartridge during installation. In particular, the recess includes a tapered locking wall in combination with a chamfered surface having a specially designed angle and length that cooperates with the locking wall and a gasket contacting wall to greatly and dramatically reduce gasket malfunction and errors during installation of the cartridges.

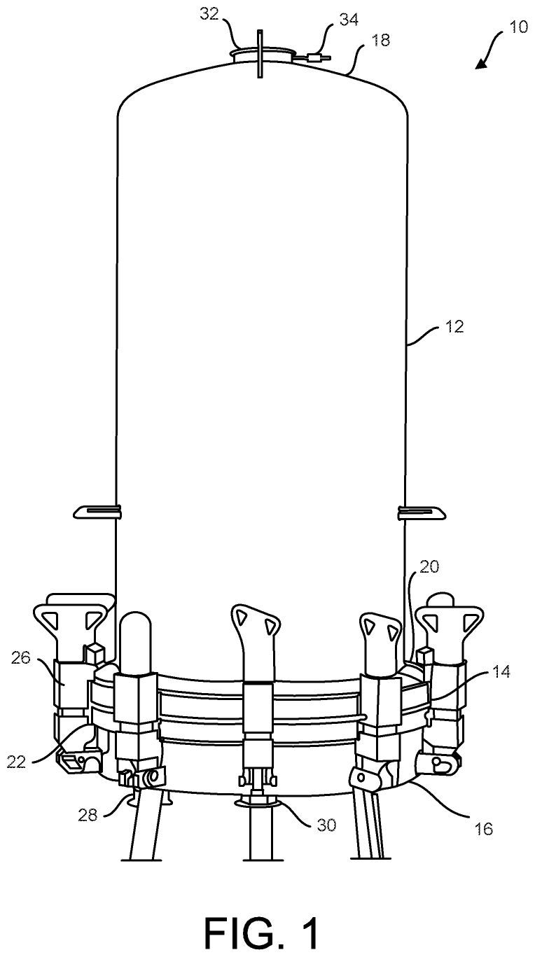

Referring to FIG. 1, for instance, one embodiment of a filter assembly 10 made in accordance with the present disclosure is shown. As illustrated, the filter assembly 10 includes a housing 12 attached to a draining and locking base 16. The housing 12 defines a hollow interior that encloses one or more filter cartridges within the filter assembly 10. The housing 12 can be made from a single piece or can be divided into separate pieces that are attached together. The filter housing 12 and the base 16 can be made from various different materials, such as metal. In one embodiment, for instance, both the housing 12 and base 16 are made from stainless steel. Other nonferrous metals that may be used to produce the housing and base include various alloys such as Iconel, Hastelloy and various aluminum alloys. Depending upon the particular application, the housing 12 and the base 16 may also be made from a high density polymer.

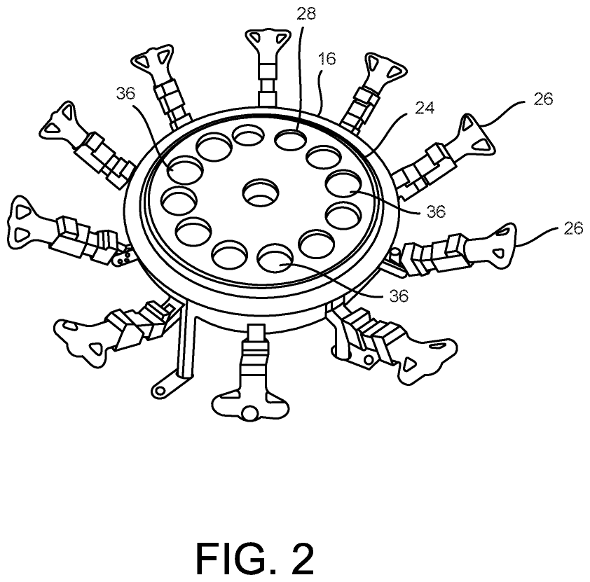

As shown, the housing 12 in the embodiment illustrated in FIG. 1 includes a closed dome end 18 and an open end 14. The open end 14 engages with the base 16. For example, the housing 12 can include a flange 20 that mates with a flange 22 on the base 16. As shown in FIG. 2, the base 16 can include a gasket or O-ring 24 that provides a fluid tight seal between the housing 12 and the base 16. As shown in FIG. 1, various different securing devices 26 can be attached to the base 16 and/or the housing 12 for securing the housing 12 to the base 16. In the embodiment illustrated in FIGS. 1 and 2, the securing devices 26 comprise a plurality of clamps that can be tightened to the housing 12 by engaging the flange 20. Alternatively, the securing devices can comprise bolts, screws, or the like.

The filter assembly 10 further includes a fluid inlet 28 and a fluid outlet 30. In the embodiment illustrated in FIG. 1, the filter assembly 10 only includes a single fluid inlet 28 and a single fluid outlet 30. It should be understood, however, that the filter assembly 10 may include a plurality of fluid inlets and/or a plurality of fluid outlets.

The housing 12 of the filter assembly 10 includes a port 32 and a valve 34 located on the closed end of the housing. The port 32 allows for access to the interior of the housing 12 and can serve as a gauge port during the filtration process. The port 32 is also designed to receive a cleaning device, such as a spray device. After a filtration process, for instance, a spray device may be inserted into the port 32 for spraying the interior of the housing including the filter cartridges. In this manner, the filter assembly can be cleaned without having to be dismantled.

The valve 34, on the other hand, is for permitting gases, such as air, to escape from the filter housing 12 during operation.

For example, during normal operation, unfiltered product, such as a fluid, is pumped into the filter assembly 10 through the fluid inlet 28. As the fluid is being filled into the housing 12, the valve 34 is open to permit trapped air to escape. After the filter assembly 10 is filled with the fluid, the valve 34 is closed. Pressure is applied to the fluid as it enters the filter assembly through the inlet 28. The pressure can be from about 5 psi to about 1000 psi. For instance, the pressure can be greater than about 10 psi, such as greater than about 20 psi, such as greater than about 30 psi, such as greater than about 50 psi. The pressure is generally less than about 500 psi, such as less than about 200 psi. As will be explained in greater detail below, the filter pressure forces the unfiltered product into the one or more filter cartridges contained within the filter assembly 10. The filter cartridges filter the fluid and remove waste, contaminants, or any other undesired components within the fluid. The filtrate or filtered product then travels down through the interior portion of the filter cartridges and out through the fluid outlet 30. The filtrate or filtered product is then collected from the fluid outlet 30.

Referring to FIG. 2, the base 16 of the filter assembly 10 is shown in greater detail. As illustrated, the base 16 includes a bore for the fluid inlet 28 and a bore for the fluid outlet 30. In addition, the base 16 includes one or more filter cartridge receiving recesses 36. In the embodiment illustrated in FIG. 2, the base 16 includes eleven filter cartridge receiving recesses 36. It should be understood, however, that in certain embodiments, the base may only include a single filter cartridge receiving recess 36. In other embodiments, however, the base 16 may include a plurality of filter cartridge receiving recesses that may number more than eleven or less than eleven. For instance, the base 16 may include greater than five filter cartridge receiving recesses 36, such as greater than ten filter cartridge receiving recesses 36. The number of filter cartridge receiving recesses on the base 16 is generally less than about 100, such as less than about 50, such as less than about 25.

In accordance with the present disclosure, the filter cartridge receiving recesses 36 are specifically designed to quickly and easily seal with a filter cartridge while minimizing or preventing gasket failure, such as O-ring rolling, which refers to an O-ring rolling out of its groove rendering it impossible for the cartridge to form a fluid tight seal with the base 16.

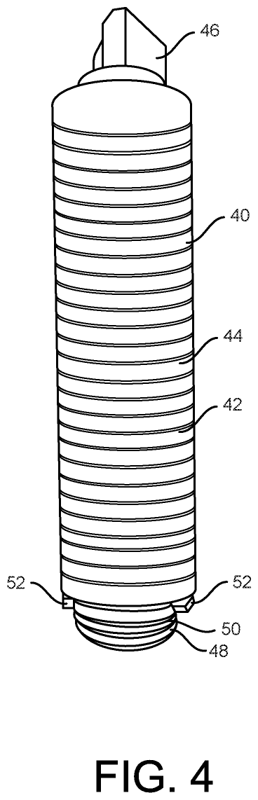

An example of a filter cartridge that may be used with the filter assembly 10 is shown in FIG. 4. The filter cartridge 40 includes a filter housing 42 that contains a filter media 44. The filter media 44 can vary depending upon the particular application and the desired result. For example, the filter cartridge 40 can be designed to filter all different types of materials. Fluids that may be filtered according to the present disclosure include pharmaceutical products, water during a purification process, food and beverage products, chemical products, and the like. The filter cartridge 40 may be designed to filter out particles and other particulates, immiscible fluids, charged particles, and the like.

Examples of filter media that may be used include any suitable filter membrane that can be made from any suitable polymer. The filter media, for instance, may comprise a hydrophilic membrane or may comprise a hydrophobic membrane. The filter media may have a pore size of less than about 0.5 microns, such as less than about 0.3 microns, such as less than about 0.25 microns. In one embodiment, the filter media comprises polyvinylidene fluoride.

As shown in FIG. 4, the filter cartridge 40 includes a first or top end 46. The top end typically comprises a closed end. In the embodiment illustrated, for instance, a plug has been inserted into the top end 46.

The filter cartridge 40 further includes a bottom end 48. Bottom end 48 is for attaching to and sealing against the base 16. As shown, the bottom end 48 includes at least one gasket 50. In the embodiment illustrated, for instance, the filter cartridge 40 includes two gaskets 50 or O-rings. The O-rings encircle the filter cartridge and are positioned in recesses formed into the cartridge.

The filter cartridge 40 further includes locking elements 52. In the embodiment illustrated, for instance, the filter cartridge 30 includes a pair of opposing locking elements 52. The locking elements 52 are for securing the filter cartridge 40 to the base 16.

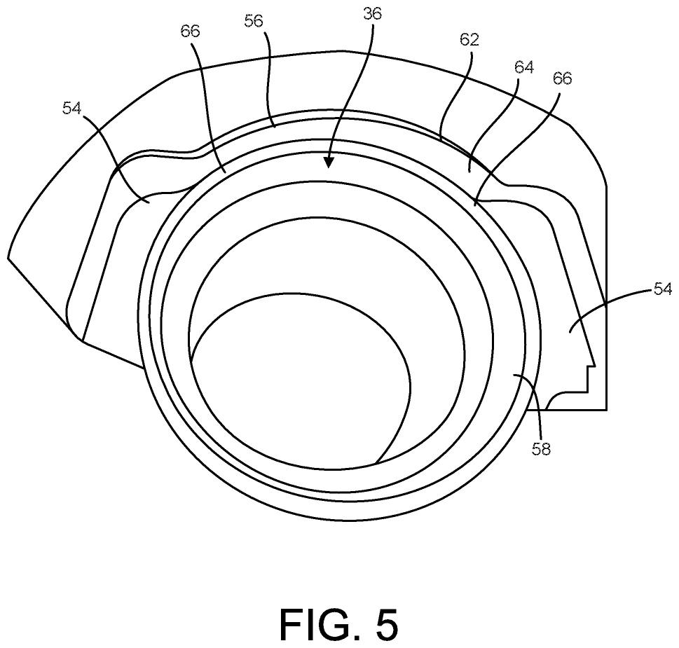

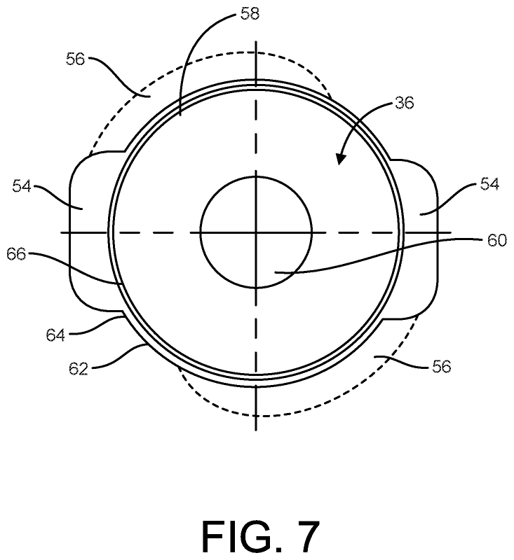

Referring to FIGS. 5, 6 and 7, the construction of the filter cartridge receiving recesses 36 will now be described in greater detail. As shown in FIG. 7, each recess includes engaging elements 54 corresponding to the locking elements 52 on the filter cartridge 40. In order to install the filter cartridge 40 into the recess 36, the locking elements 52 are coordinated with the engaging elements 54. The filter cartridge 40 is then twisted causing the locking elements 52 to become seated within corresponding slots 56. The gaskets 50 on the filter cartridge 40 contact a gasket contacting section 58 of the recess 36. The gaskets form a tension fit with the gasket contacting section 58. In particular, the gasket contacting section 58 has a diameter slightly less than the outer diameter of the gasket 50 once installed on the filter cartridge 40. Contact between the gasket 50 and gasket contacting section 58 provides a fluid tight seal between the base 16 and the filter cartridge 40.

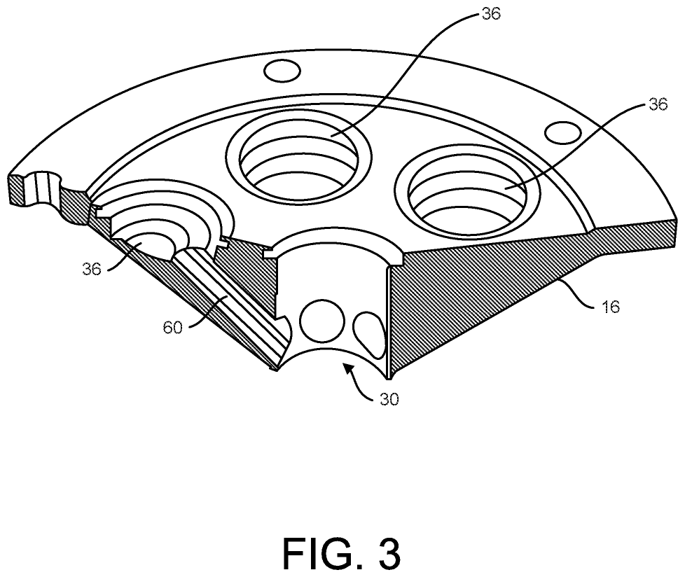

As unfiltered product enters the fluid cartridge 40, the fluid is filtered and the filtrate enters into a passageway within the filter cartridge 40. The filtrate is forced down through the cartridge and enters a channel 60 as shown in FIG. 3. The channel 60 is in fluid communication with the fluid outlet 30. The Filtrate or filter product flows through the channel 60 and out the fluid outlet 30 for collection.

As described above, during the insertion of the filter cartridge into the recess, the gaskets have a tendency to become unseated on the cartridge and malfunction. Such malfunctions are more likely to occur when various different fluids are being processed within the system. The presence of various fluids, for instance, can make it more likely for the gaskets or O-rings to roll on the filter cartridge and prevents the formation of a fluid tight seal with the base 16. In this regard, the filter cartridge receiving recesses 36 of the present disclosure include different sections on the recess that transition from the top of the recess to the gasket contacting section 58 for preventing gasket malfunctions.

For instance, as shown in FIGS. 5, 6 and 7, (not to scale), each filter cartridge receiving recess 36 includes a first section 62, adjacent a top end of the recess. The first section 62 has a first diameter that is larger than the diameter of the second end of the filter cartridge 40. In the embodiment illustrated in FIGS. 5, 6 and 7, the first section 62 includes at least one engaging element 54 for engaging an end of the filter cartridge. It should be understood, however, that the first section of the recess can be above or below the engaging elements 54.

The first section 62 of the recess 36 includes a wall 64 that defines the diameter of the first section. In accordance with the present disclosure, the wall 64 includes a tapering height. More particularly, the height of the wall 64 changes from a greatest or maximum height to a lowest or minimum height in a gradual manner. Tapering the wall 64 has been found to assist in preventing the gaskets on the filter cartridge from becoming unseated when the filter cartridge is twisted within the recess 36.

In one particular embodiment, the difference between a greatest height of the tapered wall 64 and the lowest height of the wall is generally greater than about 0.5 mm (0.01 in), such as greater than about 0.8 mm (0.03 in), such as greater than about 1 mm (0.04 in), such as greater than about 1.2 mm (0.05 in). The difference in the wall height over the taper is generally less than about 3 mm (0.15 in), such as less than about 2 mm (0.08 in), such as less than about 1.5 mm (0.06 in), such as less than about 1.2 mm (0.045 in), such as less than about 1.1 mm (0.04 in).

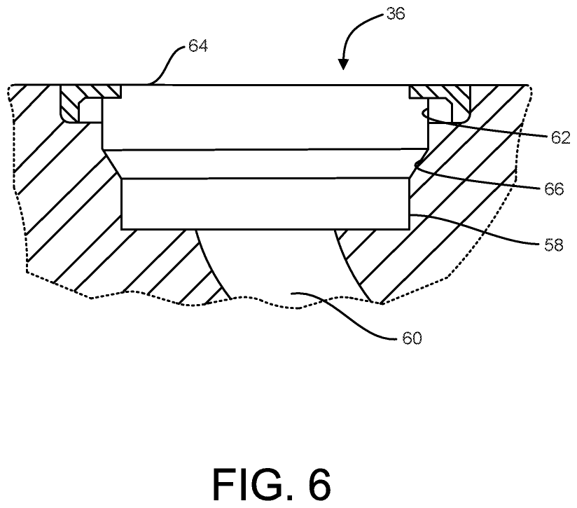

As shown in FIGS. 5 and 6, the first section 62 of the recess 36 is adjacent to a gasket guiding section 66. The gasket guiding section 66 is positioned in between the first section 62 and the gasket contacting section 58 of the recess 36. In one embodiment, for instance, the gasket guiding section 66 is positioned directly adjacent to the first section 62 on one end and directly adjacent to the gasket contacting section 58 at an opposite end. The gasket guiding section 66 is designed to guide the gaskets on the filter cartridge 40 into the gasket contacting section 58 in a manner that produces a minimal amount of stress and disturbance for allowing the gaskets to contact the wall of the gasket contacting section without becoming unseated or otherwise malfunctioning.

The gasket guiding section 66 generally comprises a chamfered surface that forms an angle with a vertical line that is parallel of the central axis of the recess. In the past, chamfered surfaces were also present in recesses on base plate assemblies. For instance, one past design included a chamfered surface having a length of 0.06 inches and having an angle of 20° with a vertical line. The present inventors, however, discovered that this design does not optimize the prevention of gasket malfunction. In accordance with the present disclosure, the gasket guiding section 66 is at an angle of greater than 20°. For instance, the gasket guiding section can have an angle of greater than about 25°, such as greater than about 30°, such as greater than about 35°, such as greater than about 40°. The gasket guiding section generally has an angle of less than about 60°, such as less than about 55°, such as less than about 50°. In one embodiment, for instance, the gasket guiding section comprises a chamfered surface having an angle of from about 43° to about 47°. The present inventors discovered that this angle in combination with a tapered first section unexpectedly and dramatically prevents O-ring rolling and other gasket malfunctions.

As shown in FIGS. 5 and 6, the gasket guiding section 66 serves to reduce the diameter of the recess 36 in a gradual manner. The gasket guiding section generally has the same diameter as the first section of the recess at a first end adjacent to the first section. At an opposite end, on the other hand, the gasket guiding section 66 has a diameter that generally matches the diameter of the gasket contacting section 58. The length of the gasket guiding section from the first end to the second end is generally greater than about 0.8 mm (0.03 in), such as greater than about 1.1 mm (0.04 in), such as greater than 1.3 mm (0.05 in), such as greater than about 1.4 mm (0.055 in). The length of the gasket guiding section is generally less than about 3.2 mm (0.15 in), such as less than about 2.6 mm (0.1 in), such as less than about 1.7 mm (0.07 in), such as less than about 1.6 mm (0.06 in).

Filter assemblies made in accordance with the present disclosure can be used in numerous and diverse applications. In one embodiment, for instance, the filter assembly can be used to filter fluids, such as liquids, during the culturing of cells, including prokaryotic and/or eukaryotic cell lines. Further, in embodiments, the devices, facilities and methods are suitable for filtering fluids during the culturing of suspension cells or anchorage-dependent (adherent) cells and are suitable for production operations configured for production of pharmaceutical and biopharmaceutical products—such as polypeptide products, nucleic acid products (for example DNA or RNA), or cells and/or viruses such as those used in cellular and/or viral therapies.

In embodiments, the cells express or produce a product, such as a recombinant therapeutic or diagnostic product. As described in more detail below, examples of products produced by cells include, but are not limited to, antibody molecules (e.g., monoclonal antibodies, bispecific antibodies), antibody mimetics (polypeptide molecules that bind specifically to antigens but that are not structurally related to antibodies such as e.g. DARPins, affibodies, adnectins, or IgNARs), fusion proteins (e.g., Fc fusion proteins, chimeric cytokines), other recombinant proteins (e.g., glycosylated proteins, enzymes, hormones), viral therapeutics (e.g., anti-cancer oncolytic viruses, viral vectors for gene therapy and viral immunotherapy), cell therapeutics (e.g., pluripotent stem cells, mesenchymal stem cells and adult stem cells), vaccines or lipid-encapsulated particles (e.g., exosomes, virus-like particles), RNA (such as e.g. siRNA) or DNA (such as e.g. plasmid DNA), antibiotics or amino acids. In embodiments, the devices, facilities and methods can be used for producing biosimilars.

As mentioned, in embodiments, devices, facilities and methods allow for the production of eukaryotic cells, e.g., mammalian cells or lower eukaryotic cells such as for example yeast cells or filamentous fungi cells, or prokaryotic cells such as Gram-positive or Gram-negative cells and/or products of the eukaryotic or prokaryotic cells, e.g., proteins, peptides, antibiotics, amino acids, nucleic acids (such as DNA or RNA), synthesised by the eukaryotic cells in a large-scale manner. Unless stated otherwise herein, the devices, facilities, and methods can include any desired volume or production capacity including but not limited to bench-scale, pilot-scale, and full production scale capacities.

Moreover and unless stated otherwise herein, the devices, facilities, and methods can include any suitable reactor(s) including but not limited to stirred tank, airlift, fiber, microfiber, hollow fiber, ceramic matrix, fluidized bed, fixed bed, and/or spouted bed bioreactors. As used herein, “reactor” can include a fermentor or fermentation unit, or any other reaction vessel and the term “reactor” is used interchangeably with “fermentor.” For example, in some aspects, an example bioreactor unit can perform one or more, or all, of the following: feeding of nutrients and/or carbon sources, injection of suitable gas (e.g., oxygen), inlet and outlet flow of fermentation or cell culture medium, separation of gas and liquid phases, maintenance of temperature, maintenance of oxygen and CO2 levels, maintenance of pH level, agitation (e.g., stirring), and/or cleaning/sterilizing. Example reactor units, such as a fermentation unit, may contain multiple reactors within the unit, for example the unit can have 1, 2, 3, 4, 5, 10, 15, 20, 25, 30, 35, 40, 45, 50, 60, 70, 80, 90, or 100, or more bioreactors in each unit and/or a facility may contain multiple units having a single or multiple reacotrs within the facility. In various embodiments, the bioreactor can be suitable for batch, semi fed-batch, fed-batch, perfusion, and/or a continuous fermentation processes. Any suitable reactor diameter can be used. In embodiments, the bioreactor can have a volume between about 100 mL and about 50,000 L. Non-limiting examples include a volume of 100 mL, 250 mL, 500 mL, 750 mL, 1 liter, 2 liters, 3 liters, 4 liters, 5 liters, 6 liters, 7 liters, 8 liters, 9 liters, 10 liters, 15 liters, 20 liters, 25 liters, 30 liters, 40 liters, 50 liters, 60 liters, 70 liters, 80 liters, 90 liters, 100 liters, 150 liters, 200 liters, 250 liters, 300 liters, 350 liters, 400 liters, 450 liters, 500 liters, 550 liters, 600 liters, 650 liters, 700 liters, 750 liters, 800 liters, 850 liters, 900 liters, 950 liters, 1000 liters, 1500 liters, 2000 liters, 2500 liters, 3000 liters, 3500 liters, 4000 liters, 4500 liters, 5000 liters, 6000 liters, 7000 liters, 8000 liters, 9000 liters, 10,000 liters, 15,000 liters, 20,000 liters, and/or 50,000 liters. Additionally, suitable reactors can be multi-use, single-use, disposable, or non-disposable and can be formed of any suitable material including metal alloys such as stainless steel (e.g., 316L or any other suitable stainless steel) and Inconel, plastics, and/or glass.

In embodiments and unless stated otherwise herein, the devices, facilities, and methods described herein can also include any suitable unit operation and/or equipment not otherwise mentioned, such as operations and/or equipment for separation, purification, and isolation of such products. Any suitable facility and environment can be used, such as traditional stick-built facilities, modular, mobile and temporary facilities, or any other suitable construction, facility, and/or layout. For example, in some embodiments modular clean-rooms can be used. Additionally and unless otherwise stated, the devices, systems, and methods described herein can be housed and/or performed in a single location or facility or alternatively be housed and/or performed at separate or multiple locations and/or facilities.

By way of non-limiting examples and without limitation, U.S. Publication Nos. 2013/0280797; 2012/0077429; 2011/0280797; 2009/0305626; and U.S. Pat. Nos. 8,298,054; 7,629,167; and 5,656,491, which are hereby incorporated by reference in their entirety, describe example facilities, equipment, and/or systems that may be suitable.

In embodiments, the cells are eukaryotic cells, e.g., mammalian cells. The mammalian cells can be for example human or rodent or bovine cell lines or cell strains. Examples of such cells, cell lines or cell strains are e.g. mouse myeloma (NSO)-cell lines, Chinese hamster ovary (CHO)-cell lines, HT1080, H9, HepG2, MCF7, MDBK Jurkat, NIH3T3, PC12, BHK (baby hamster kidney cell), VERO, SP2/0, YB2/0, Y0, C127, L cell, COS, e.g., COS1 and COS7, QC1-3, HEK-293, VERO, PER.C6, HeLA, EBI, EB2, EB3, oncolytic or hybridoma-cell lines. Preferably the mammalian cells are CHO-cell lines. In one embodiment, the cell is a CHO cell. In one embodiment, the cell is a CHO-K1 cell, a CHO-K1 SV cell, a DG44 CHO cell, a DUXB11 CHO cell, a CHOS, a CHO GS knock-out cell, a CHO FUT8 GS knock-out cell, a CHOZN, or a CHO-derived cell. The CHO GS knock-out cell (e.g., GSKO cell) is, for example, a CHO-K1 SV GS knockout cell. The CHO FUT8 knockout cell is, for example, the Potelligent® CHOK1 SV (Lonza Biologics, Inc.). Eukaryotic cells can also be avian cells, cell lines or cell strains, such as for example, EBx® cells, EB14, EB24, EB26, EB66, or EBvl3.

In one embodiment, the eukaryotic cells are stem cells. The stem cells can be, for example, pluripotent stem cells, including embryonic stem cells (ESCs), adult stem cells, induced pluripotent stem cells (iPSCs), tissue specific stem cells (e.g., hematopoietic stem cells) and mesenchymal stem cells (MSCs).

In one embodiment, the cell is a differentiated form of any of the cells described herein. In one embodiment, the cell is a cell derived from any primary cell in culture.

In embodiments, the cell is a hepatocyte such as a human hepatocyte, animal hepatocyte, or a non-parenchymal cell. For example, the cell can be a plateable metabolism qualified human hepatocyte, a plateable induction qualified human hepatocyte, plateable Qualyst Transporter Certified™ human hepatocyte, suspension qualified human hepatocyte (including 10-donor and 20-donor pooled hepatocytes), human hepatic kupffer cells, human hepatic stellate cells, dog hepatocytes (including single and pooled Beagle hepatocytes), mouse hepatocytes (including CD-1 and C57BI/6 hepatocytes), rat hepatocytes (including Sprague-Dawley, Wistar Han, and Wistar hepatocytes), monkey hepatocytes (including Cynomolgus or Rhesus monkey hepatocytes), cat hepatocytes (including Domestic Shorthair hepatocytes), and rabbit hepatocytes (including New Zealand White hepatocytes). Example hepatocytes are commercially available from Triangle Research Labs, LLC, 6 Davis Drive Research Triangle Park, N.C., USA 27709.

In one embodiment, the eukaryotic cell is a lower eukaryotic cell such as e.g. a yeast cell (e.g., Pichia genus (e.g. Pichia pastoris, Pichia methanolica, Pichia kluyveri, and Pichia angusta), Komagataella genus (e.g. Komagataella pastoris, Komagataella pseudopastoris or Komagataella phaffii), Saccharomyces genus (e.g. Saccharomyces cerevisae, cerevisiae, Saccharomyces kluyveri, Saccharomyces uvarum), Kluyveromyces genus (e.g. Kluyveromyces lactis, Kluyveromyces marxianus), the Candida genus (e.g. Candida utilis, Candida cacaoi, Candida boidinii), the Geotrichum genus (e.g. Geotrichum fermentans), Hansenula polymorpha, Yarrowia lipolytica, or Schizosaccharomyces pombe. Preferred is the species Pichia pastoris. Examples for Pichia pastoris strains are X33, GS115, KM71, KM71H; and CBS7435.

In one embodiment, the eukaryotic cell is a fungal cell (e.g. Aspergillus (such as A. niger, A. fumigatus, A. orzyae, A. nidula), Acremonium (such as A. thermophilum), Chaetomium (such as C. thermophilum), Chrysosporium (such as C. thermophile), Cordyceps (such as C. militaris), Corynascus, Ctenomyces, Fusarium (such as F. oxysporum), Glomerella (such as G. graminicola), Hypocrea (such as H. jecorina), Magnaporthe (such as M. orzyae), Myceliophthora (such as M. thermophile), Nectria (such as N. heamatococca), Neurospora (such as N. crassa), Penicillium, Sporotrichum (such as S. thermophile), Thielavia (such as T. terrestris, T. heterothallica), Trichoderma (such as T. reesei), or Verticillium (such as V. dahlia)).

In one embodiment, the eukaryotic cell is an insect cell (e.g., Sf9, Mimic™ Sf9, Sf21, High Five™ (BT1-TN-5B1-4), or BT1-Ea88 cells), an algae cell (e.g., of the genus Amphora, Bacillariophyceae, Dunaliella, Chlorella, Chlamydomonas, Cyanophyta (cyanobacteria), Nannochloropsis, Spirulina,or Ochromonas), or a plant cell (e.g., cells from monocotyledonous plants (e.g., maize, rice, wheat, or Setaria), or from a dicotyledonous plants (e.g., cassava, potato, soybean, tomato, tobacco, alfalfa, Physcomitrella patens or Arabidopsis).

In one embodiment, the cell is a bacterial or prokaryotic cell.

In embodiments, the prokaryotic cell is a Gram-positive cells such as Bacillus, Streptomyces Streptococcus, Staphylococcus or Lactobacillus. Bacillus that can be used is, e.g. the B. subtilis, B. amyloliquefaciens, B. licheniformis, B. natto, or B. megaterium. In embodiments, the cell is B. subtilis, such as B. subtilis 3 NA and B. subtilis 168. Bacillus is obtainable from, e.g., the Bacillus Genetic Stock Center, Biological Sciences 556, 484 West 12^{th} Avenue, Columbus Ohio 43210-1214.

In one embodiment, the prokaryotic cell is a Gram-negative cell, such as Salmonella spp. or Escherichia co/i, such as e.g., TG1, TG2, W3110, DH1, DHB4, DH5a, HMS 174, HMS174 (DE3), NM533, C600, HB101, JM109, MC4100, XL1-Blue and Origami, as well as those derived from E. coli B-strains, such as for example BL-21 or BL21 (DE3), all of which are commercially available.

Suitable host cells are commercially available, for example, from culture collections such as the DSMZ (Deutsche Sammlung von Mikroorganismen and Zellkulturen GmbH, Braunschweig, Germany) or the American Type Culture Collection (ATCC).

In embodiments, the cultured cells are used to produce proteins e.g., antibodies, e.g., monoclonal antibodies, and/or recombinant proteins, for therapeutic use. In embodiments, the cultured cells produce peptides, amino acids, fatty acids or other useful biochemical intermediates or metabolites. For example, in embodiments, molecules having a molecular weight of about 4000 daltons to greater than about 140,000 daltons can be produced. In embodiments, these molecules can have a range of complexity and can include posttranslational modifications including glycosylation.

In embodiments, the protein is, e.g., BOTOX, Myobloc, Neurobloc, Dysport (or other serotypes of botulinum neurotoxins), alglucosidase alpha, daptomycin, YH-16, choriogonadotropin alpha, filgrastim, cetrorelix, interleukin-2, aldesleukin, teceleulin, denileukin diftitox, interferon alpha-n3 (injection), interferon alpha-nl, DL-8234, interferon, Suntory (gamma-1a), interferon gamma, thymosin alpha 1, tasonermin, DigiFab, ViperaTAb, EchiTAb, CroFab, nesiritide, abatacept, alefacept, Rebif, eptoterminalfa, teriparatide (osteoporosis), calcitonin injectable (bone disease), calcitonin (nasal, osteoporosis), etanercept, hemoglobin glutamer 250 (bovine), drotrecogin alpha, collagenase, carperitide, recombinant human epidermal growth factor (topical gel, wound healing), DWP401, darbepoetin alpha, epoetin omega, epoetin beta, epoetin alpha, desirudin, lepirudin, bivalirudin, nonacog alpha, Mononine, eptacog alpha (activated), recombinant Factor VIII+VWF, Recombinate, recombinant Factor VIII, Factor VIII (recombinant), Alphnmate, octocog alpha, Factor VIII, palifermin,Indikinase, tenecteplase, alteplase, pamiteplase, reteplase, nateplase, monteplase, follitropin alpha, rFSH, hpFSH, micafungin, pegfilgrastim, lenograstim, nartograstim, sermorelin, glucagon, exenatide, pramlintide, iniglucerase, galsulfase, Leucotropin, molgramostirn, triptorelin acetate, histrelin (subcutaneous implant, Hydron), deslorelin, histrelin, nafarelin, leuprolide sustained release depot (ATRIGEL), leuprolide implant (DUROS), goserelin, Eutropin, KP-102 program, somatropin, mecasermin (growth failure), enlfavirtide, Org-33408, insulin glargine, insulin glulisine, insulin (inhaled), insulin lispro, insulin deternir, insulin (buccal, RapidMist), mecasermin rinfabate, anakinra, celmoleukin, 99 mTc-apcitide injection, myelopid, Betaseron, glatiramer acetate, Gepon, sargramostim, oprelvekin, human leukocyte-derived alpha interferons, Bilive, insulin (recombinant), recombinant human insulin, insulin aspart, mecasenin, Roferon-A, interferon-alpha 2, Alfaferone, interferon alfacon-1, interferon alpha, Avonex's recombinant human luteinizing hormone, dornase alpha, trafermin, ziconotide, taltirelin, diboterminalfa, atosiban, becaplerm in, eptifibatide, Zemaira, CTC-111, Shanvac-B, HPV vaccine (quadrivalent), octreotide, lanreotide, ancestirn, agalsidase beta, agalsidase alpha, laronidase, prezatide copper acetate (topical gel), rasburicase, ranibizumab, Actimmune, PEG-Intron, Tricomin, recombinant house dust mite allergy desensitization injection, recombinant human parathyroid hormone (PTH) 1-84 (sc, osteoporosis), epoetin delta, transgenic antithrombin III, Granditropin, Vitrase, recombinant insulin, interferon-alpha (oral lozenge), GEM-21S, vapreotide, idursulfase, omnapatrilat, recombinant serum albumin, certolizumab pegol, glucarpidase, human recombinant Cl esterase inhibitor (angioedema), lanoteplase, recombinant human growth hormone, enfuvirtide (needle-free injection, Biojector 2000), VGV-1, interferon (alpha), lucinactant, aviptadil (inhaled, pulmonary disease), icatibant, ecallantide, omiganan, Aurograb, pexigananacetate, ADI-PEG-20, LDI-200, degarelix, cintredelinbesudotox, Favld, MDX-1379, ISAtx-247, liraglutide, teriparatide (osteoporosis), tifacogin, AA4500, T4N5 liposome lotion, catumaxomab, DWP413, ART-123, Chrysalin, desmoteplase, amediplase, corifollitropinalpha, TH-9507, teduglutide, Diamyd, DWP-412, growth hormone (sustained release injection), recombinant G-CSF, insulin (inhaled, AIR), insulin (inhaled, Technosphere), insulin (inhaled, AERx), RGN-303, DiaPep277, interferon beta (hepatitis C viral infection (HCV)), interferon alpha-n3 (oral), belatacept, transdermal insulin patches, AMG-531, MBP-8298, Xerecept, opebacan, AIDSVAX, GV-1001, LymphoScan, ranpirnase, Lipoxysan, lusupultide, MP52 (beta-tricalciumphosphate carrier, bone regeneration), melanoma vaccine, sipuleucel-T, CTP-37, Insegia, vitespen, human thrombin (frozen, surgical bleeding), thrombin, TransMlD, alfimeprase, Puricase, terlipressin (intravenous, hepatorenal syndrome), EUR-1008M, recombinant FGF-I (injectable, vascular disease), BDM-E, rotigaptide, ETC-216, P-113, MBI-594AN, duramycin (inhaled, cystic fibrosis), SCV-07, OPI-45, Endostatin, Angiostatin, ABT-510, Bowman Birk Inhibitor Concentrate, XMP-629, 99 mTc-Hynic-Annexin V, kahalalide F, CTCE-9908, teverelix (extended release), ozarelix, rornidepsin, BAY-504798, interleukin4, PRX-321, Pepscan, iboctadekin, rhlactoferrin, TRU-015, IL-21, ATN-161, cilengitide, Albuferon, Biphasix, IRX-2, omega interferon, PCK-3145, CAP-232, pasireotide, huN901-DMI, ovarian cancer immunotherapeutic vaccine, SB-249553, Oncovax-CL, OncoVax-P, BLP-25, CerVax-16, multi-epitope peptide melanoma vaccine (MART-1, gp100, tyrosinase), nemifitide, rAAT (inhaled), rAAT (dermatological), CGRP (inhaled, asthma), pegsunercept, thymosinbeta4, plitidepsin, GTP-200, ramoplanin, GRASPA, OBI-1, AC-100, salmon calcitonin (oral, eligen), calcitonin (oral, osteoporosis), examorelin, capromorelin, Cardeva, velafermin, 131I-TM-601, KK-220, T-10, ularitide, depelestat, hematide, Chrysalin (topical), rNAPc2, recombinant Factor V111 (PEGylated liposomal), bFGF, PEGylated recombinant staphylokinase variant, V-10153, SonoLysis Prolyse, NeuroVax, CZEN-002, islet cell neogenesis therapy, rGLP-1, BIM-51077, LY-548806, exenatide (controlled release, Medisorb), AVE-0010, GA-GCB, avorelin, ACM-9604, linaclotid eacetate, CETi-1, Hemospan, VAL (injectable), fast-acting insulin (injectable, Viadel), intranasal insulin, insulin (inhaled), insulin (oral, eligen), recombinant methionyl human leptin, pitrakinra subcutancous injection, eczema), pitrakinra (inhaled dry powder, asthma), Multikine, RG-1068, MM-093, NBI-6024, AT-001, PI-0824, Org-39141, Cpn10 (autoimmune diseases/inflammation), talactoferrin (topical), rEV-131 (ophthalmic), rEV-131 (respiratory disease), oral recombinant human insulin (diabetes), RPI-78M, oprelvekin (oral), CYT-99007 CTLA4-Ig, DTY-001, valategrast, interferon alpha-n3 (topical), IRX-3, RDP-58, Tauferon, bile salt stimulated lipase, Merispase, alaline phosphatase, EP-2104R, Melanotan-II, bremelanotide, ATL-104, recombinant human microplasmin, AX-200, SEMAX, ACV-1, Xen-2174, CJC-1008, dynorphin A, SI-6603, LAB GHRH, AER-002, BGC-728, malaria vaccine (virosomes, PeviPRO), ALTU-135, parvovirus B19 vaccine, influenza vaccine (recombinant neuraminidase), malaria/HBV vaccine, anthrax vaccine, Vacc-5q, Vacc-4x, HIV vaccine (oral), HPV vaccine, Tat Toxoid, YSPSL, CHS-13340, PTH(1-34) liposomal cream (Novasome), Ostabolin-C, PTH analog (topical, psoriasis), MBRI-93.02, MTB72F vaccine (tuberculosis), MVA-Ag85A vaccine (tuberculosis), FARA04, BA-210, recombinant plague FIV vaccine, AG-702, OxSODrol, rBetV1, Der-p1/Der-p2/Der-p7 allergen-targeting vaccine (dust mite allergy), PR1 peptide antigen (leukemia), mutant ras vaccine, HPV-16 E7 lipopeptide vaccine, labyrinthin vaccine (adenocarcinoma), CML vaccine, WT1-peptide vaccine (cancer), IDD-5, CDX-110, Pentrys, Norelin, CytoFab, P-9808, VT-111, icrocaptide, telbermin (dermatological, diabetic foot ulcer), rupintrivir, reticulose, rGRF, HA, alpha-galactosidase A, ACE-011, ALTU-140, CGX-1160, angiotensin therapeutic vaccine, D-4F, ETC-642, APP-018, rhMBL, SCV-07 (oral, tuberculosis), DRF-7295, ABT-828, ErbB2-specific immunotoxin (anticancer), DT3SSIL-3, TST-10088, PRO-1762, Combotox, cholecystokinin-B/gastrin-receptor binding peptides, 111In-hEGF, AE-37, trasnizumab-DM1, Antagonist G, IL-12 (recombinant), PM-02734, IMP-321, rhIGF-BP3, BLX-883, CUV-1647 (topical), L-19 based radioimmunotherapeutics (cancer), Re-188-P-2045, AMG-386, DC/1540/KLH vaccine (cancer), VX-001, AVE-9633, AC-9301, NY-ESO-1 vaccine (peptides), NA17.A2 peptides, melanoma vaccine (pulsed antigen therapeutic), prostate cancer vaccine, CBP-501, recombinant human lactoferrin (dry eye), FX-06, AP-214, WAP-8294A (injectable), ACP-HIP, SUN-11031, peptide YY [3-36] (obesity, intranasal), FGLL, atacicept, BR3-Fc, BN-003, BA-058, human parathyroid hormone 1-34 (nasal, osteoporosis), F-18-CCR1, AT-1100 (celiac disease/diabetes), JPD-003, PTH(7-34) liposomal cream (Novasome), duramycin (ophthalmic, dry eye), CAB-2, CTCE-0214, GlycoPEGylated erythropoietin, EPO-Fc, CNTO-528, AMG-114, JR-013, Factor XIII, aminocandin, PN-951, 716155, SUN-E7001, TH-0318, BAY-73-7977, teverelix (immediate release), EP-51216, hGH (controlled release, Biosphere), OGP-I, sifuvirtide, TV4710, ALG-889, Org-41259, rhCC10, F-991, thymopentin (pulmonary diseases), r(m)CRP, hepatoselective insulin, subalin, L19-IL-2 fusion protein, elafin, NMK-150, ALTU-139, EN-122004, rhTPO, thrombopoietin receptor agonist (thrombocytopenic disorders), AL-108, AL-208, nerve growth factor antagonists (pain), SLV-317, CGX-1007, INNO-105, oral teriparatide (eligen), GEM-OS1, AC-162352, PRX-302, LFn-p24 fusion vaccine (Therapore), EP-1043, S pneumoniae pediatric vaccine, malaria vaccine, Neisseria meningitidis Group B vaccine, neonatal group B streptococcal vaccine, anthrax vaccine, HCV vaccine (gpE1+gpE2+MF-59), otitis media therapy, HCV vaccine (core antigen+ISCOMATRIX), hPTH(1-34) (transdermal, ViaDerm), 768974, SYN-101, PGN-0052, aviscumnine, BIM-23190, tuberculosis vaccine, multi-epitope tyrosinase peptide, cancer vaccine, enkastim, APC-8024, GI-5005, ACC-001, TTS-CD3, vascular-targeted TNF (solid tumors), desmopressin (buccal controlled-release), onercept, and TP-9201.

In some embodiments, the polypeptide is adalimumab (HUMIRA), infliximab (REMICADE™), rituximab (RITUXAN™/MAB THERA™) etanercept (ENBREL™), bevacizumab (AVASTIN™), trastuzumab (HERCEPTIN™), pegrilgrastim (NEULASTA™), or any other suitable polypeptide including biosimilars and biobetters.

Other suitable polypeptides are those listed below and in Table 1 of US2016/0097074:

TABLE I

| Protein Product | Reference Listed Drug |
|---|---|
| interferon gamma-1b | Actimmune ® |
| alteplase; tissue plasminogen activator | Activase ®/Cathflo ® |
| Recombinant antihemophilic factor | Advate |
| human albumin | Albutein ® |
| Laronidase | Aldurazyme ® |
| Interferon alfa-N3, human leukocyte derived | Alferon N ® |
| human antihemophilic factor | Alphanate ® |
| virus-filtered human coagulation factor IX | AlphaNine ® SD |
| Alefacept; recombinant, dimeric fusion | Amevive ® |
| protein LFA3-Ig | |
| Bivalirudin | Angiomax ® |
| darbepoetin alfa | Aranesp ™ |
| Bevacizumab | Avastin ™ |
| interferon beta-1a; recombinant | Avonex ® |
| coagulation factor IX | BeneFix ™ |
| Interferon beta-1b | Betaseron ® |
| Tositumomab | BEXXAR ® |
| antihemophilic factor | Bioclate ™ |
| human growth hormone | BioTropin ™ |
| botulinum toxin type A | BOTOX ® |
| Alemtuzumab | Campath ® |
| acritumomab; technetium-99 labeled | CEA-Scan ® |
| alglucerase; modified form of beta- | Ceredase ® |
| glucocerebrosidase | |
| imiglucerase; recombinant form of beta- | Cerezyme ® |
| glucocerebrosidase | |
| crotalidae polyvalent immune Fab, ovine | CroFab ™ |
| digoxin immune fab [ovine] | DigiFab ™ |
| Rasburicase | Elitek ® |
| Etanercept | ENBREL ® |
| epoietin alfa | Epogen ® |
| Cetuximab | Erbitux ™ |
| algasidase beta | Fabrazyme ® |
| Urofollitropin | Fertinex ™ |
| follitropin beta | Follistim ™ |
| Teriparatide | FORTEO ® |
| human somatropin | GenoTropin ® |
| Glucagon | GlucaGen ® |
| follitropin alfa | Gonal-F ® |
| antihemophilic factor | Helixate ® |
| Antihemophilic Factor; Factor XIII | HEMOFIL |
| adefovir dipivoxil | Hepsera ™ |
| Trastuzumab | Herceptin ® |
| Insulin | Humalog ® |
| antihemophilic factor/von Willebrand factor | Humate-P ® |
| complex-human | |
| Somatotropin | Humatrope ® |
| Adalimumab | HUMIRA ™ |
| human insulin | Humulin ® |
| recombinant human hyaluronidase | Hylenex ™ |
| interferon alfacon-1 | Infergen ® |
| eptifibatide | Integrilin ™ |
| alpha-interferon | Intron A ® |
| Palifermin | Kepivance |
| Anakinra | Kineret ™ |
| antihemophilic factor | Kogenate ® FS |
| insulin glargine | Lantus ® |
| granulocyte macrophage colony-stimulating | Leukine ®/Leukine ® |
| factor | Liquid |
| lutropin alfa for injection | Luveris |
| OspA lipoprotein | LYMErix ™ |
| Ranibizumab | LUCENTIS ® |
| gemtuzumab ozogamicin | Mylotarg ™ |
| Galsulfase | Naglazyme ™ |
| Nesiritide | Natrecor ® |
| Pegfilgrastim | Neulasta ™ |
| Oprelvekin | Neumega ® |
| Filgrastim | Neupogen ® |
| Fanolesomab | NeutroSpec ™ (formerly |
| | LeuTech ®) |
| somatropin [rDNA] | Norditropin ®/Norditropin |
| | Nordiflex ® |
| Mitoxantrone | Novantrone ® |
| insulin; zinc suspension; | Novolin L ® |
| insulin; isophane suspension | Novolin N ® |
| insulin, regular; | Novolin R ® |
| Insulin | Novolin ® |
| coagulation factor VIIa | NovoSeven ® |
| Somatropin | Nutropin ® |
| immunoglobulin intravenous | Octagam ® |
| PEG-L-asparaginase | Oncaspar ® |
| abatacept, fully human soluable fusion | Orencia ™ |
| protein | |
| muromomab-CD3 | Orthoclone OKT3 ® |
| high-molecular weight hyaluronan | Orthovisc ® |
| human chorionic gonadotropin | Ovidrel ® |
| live attenuated Bacillus Calmette-Guerin | Pacis ® |
| peginterferon alfa-2a | Pegasys ® |
| pegylated version of interferon alfa-2b | PEG-Intron ™ |
| Abarelix (injectable suspension); | Plenaxis ™ |
| gonadotropin-releasing hormone | |
| antagonist | |
| epoietin alfa | Procrit ® |
| Aldesleukin | Proleukin, IL-2 ® |
| Somatrem | Protropin ® |
| dornase alfa | Pulmozyme ® |
| Efalizumab; selective, reversible T-cell | RAPTIVA ™ |
| blocker | |
| combination of ribavirin and alpha interferon | Rebetron ™ |
| Interferon beta 1a | Rebif ® |
| antihemophilic factor | Recombinate ® rAHF/ |
| antihemophilic factor | ReFacto ® |
| Lepirudin | Refludan ® |
| Infliximab | REMICADE ® |
| Abciximab | ReoPro ™ |
| Reteplase | Retavase ™ |
| Rituxima | Rituxan ™ |
| interferon alfa-2^{a} | Roferon-A ® |
| Somatropin | Saizen ® |
| synthetic porcine secretin | SecreFlo ™ |
| Basiliximab | Simulect ® |
| Eculizumab | SOLIRIS (R) |
| Pegvisomant | SOMAVERT ® |
| Palivizumab; recombinantly produced, | Synagis ™ |
| humanized mAb | |
| thyrotropin alfa | Thyrogen ® |
| Tenecteplase | TNKase ™ |
| Natalizumab | TYSABRI ® |
| human immune globulin intravenous 5% | Venoglobulin-S ® |
| and 10% solutions | |
| interferon alfa-n1, lymphoblastoid | Wellferon ® |
| drotrecogin alfa | Xigris ™ |
| Omalizumab; recombinant DNA-derived | Xolair ® |
| humanized monoclonal | |
| antibody targeting immunoglobulin-E | |
| Daclizumab | Zenapax ® |
| ibritumomab tiuxetan | Zevalin ™ |
| Somatotropin | Zorbtive ™ (Serostim ®) |

In embodiments, the polypeptide is a hormone, blood clotting/coagulation factor, cytokine/growth factor, antibody molecule, fusion protein, protein vaccine, or peptide as shown in Table 2.

TABLE 2
Exemplary Products

| Therapeutic | | |
|---|---|---|
| Product type | Product | Trade Name |
| Hormone | Erythropoietin, Epoein-α | Epogen, Procrit |
| | Darbepoetin-α | Aranesp |
| | Growth hormone (GH), | Genotropin, Humatrope, Norditropin, |
| | somatotropin | NovIVitropin, Nutropin, Omnitrope, |
| | | Protropin, Siazen, Serostim, Valtropin |
| | | Gonal-F, Follistim |
| | Human follicle-stimulating | Ovidrel |
| | hormone (FSH) | |
| | Human chorionic | Luveris |
| | gonadotropin | |
| | Lutropin-α | GlcaGen |
| | Glucagon | Geref |
| | Growth hormone releasing | ChiRhoStim (human peptide), |
| | hormone (GHRH) | SecreFlo (porcine peptide) |
| | Secretin | |
| | Thyroid stimulating | Thyrogen |
| | hormone (TSH), | |
| | thyrotropin | |
| Blood | Factor VIIa | NovoSeven |
| Clotting/Coagulation | Factor VIII | Bioclate, Helixate, Kogenate, |
| Factors | Factor IX | Recombinate, ReFacto |
| | Antithrombin III (AT-III) | Benefix |
| | Protein C concentrate | Thrombate III |
| | | Ceprotin |
| Cytokine/Growth | Type I alpha-interferon | Infergen |
| factor | Interferon-αn3 (IFNαn3) | Alferon N |
| | Interferon-β1a (rIFN-β) | Avonex, Rebif |
| | Interferon-β1b (rIFN-β) | Betaseron |
| | Interferon-γ1b (IFNγ) | Actimmune |
| | Aldesleukin (interleukin | Proleukin |
| | 2(IL2), epidermal | |
| | theymocyte activating | |
| | factor; ETAF | |
| | Palifermin (keratinocyte | Kepivance |
| | growth factor; KGF) | |
| | Becaplemin (platelet- | Regranex |
| | derived growth factor; | |
| | PDGF) | |
| | Anakinra (recombinant IL1 | Anril, Kineret |
| | antagonist) | |
| Antibody molecules | Bevacizumab (VEGFA | Avastin |
| | mAb) | |
| | Cetuximab (EGFR mAb) | Erbitux |
| | Panitumumab (EGFR | Vectibix |
| | mAb) | |
| | Alemtuzumab (CD52 | Campath |
| | mAb) | |
| | Rituximab (CD20 chimeric | Rituxan |
| | Ab) | |
| | Trastuzumab (HER2/Neu | Herceptin |
| | mAb) | |
| | Abatacept (CTLA Ab/Fc | Orencia |
| | fusion) | |
| | Adalimumab (TNFαmAb) | Humira |
| | Etanercept (TNF | Enbrel |
| | receptor/Fc fusion) | |
| | Infliximab (TNFαchimeric | Remicade |
| | mAb) | |
| | Alefacept (CD2 fusion | Amevive |
| | protein) | |
| | Efalizumab (CD11a mAb) | Raptiva |
| | Natalizumab (integrin α4 | Tysabri |
| | subunit mAb) | |
| | Eculizumab (C5mAb) | Soliris |
| | Muromonab-CD3 | Orthoclone, OKT3 |
| Other: | Insulin | Humulin, Novolin |
| Fusion | Hepatitis B surface | Engerix, Recombivax HB |
| proteins/Protein | antigen (HBsAg) | |
| vaccines/Peptides | HPV vaccine | Gardasil |
| | OspA | LYMErix |
| | Anti-Rhesus(Rh) | Rhophylac |
| | immunoglobulin G | |
| | Enfuvirtide | Fuzeon |
| | Spider silk, e.g., fibrion | QMONOS |

In embodiments, the protein is multispecific protein, e.g., a bispecific antibody as shown in Table 3.

TABLE 3

| Bispecific Formats | | | | | |
|---|---|---|---|---|---|
| Name (other | | | | | |
| names, | | | Proposed | | Diseases (or |
| sponsoring | BsAb | | mechanisms | Development | healthy |
| organizations) | format | Targets | of action | stages | volunteers) |
| Catumaxomab | BsIgG: | CD3, | Retargeting of | Approved in | Malignant |
| (Removab ®, | Triomab | EpCAM | T cells to | EU | ascites in |
| Fresenius | | | tumor, Fc | | EpCAM |
| Biotech, Trion | | | mediated | | positive tumors |
| Pharma, | | | effector | | |
| Neopharm) | | | functions | | |
| Ertumaxomab | BsIgG: | CD3, | Retargeting of | Phase I/II | Advanced solid |
| (Neovii Biotech, | Triomab | HER2 | T cells to | | tumors |
| Fresenius | | | tumor | | |
| Biotech) | | | | | |
| Blinatumomab | BiTE | CD3, | Retargeting of | Approved in | Precursor B- |
| (Blincyto ®, AMG | | CD19 | T cells to | USA | cell ALL |
| 103, MT 103, | | | tumor | Phase II and | ALL |
| MEDI 538, | | | | III | DLBCL |
| Amgen) | | | | Phase II | NHL |
| | | | | Phase I | |
| REGN1979 | BsAb | CD3, | | | |
| (Regeneron) | | CD20 | | | |
| Solitomab (AMG | BiTE | CD3, | Retargeting of | Phase I | Solid tumors |
| 110, MT110, | | EpCAM | T cells to | | |
| Amgen) | | | tumor | | |
| MEDI 565 (AMG | BiTE | CD3, | Retargeting of | Phase I | Gastrointestinal |
| 211, | | CEA | T cells to | | adenocancinoma |
| MedImmune, | | | tumor | | |
| Amgen) | | | | | |
| RO6958688 | BsAb | CD3, | | | |
| (Roche) | | CEA | | | |
| BAY2010112 | BiTE | CD3, | Retargeting of | Phase I | Prostate |
| (AMG 212, | | PSMA | T cells to | | cancer |
| Bayer; Amgen) | | | tumor | | |
| MGD006 | DART | CD3, | Retargeting of | Phase I | AML |
| (Macrogenics) | | CD123 | T cells to | | |
| | | | tumor | | |
| MGD007 | DART | CD3, | Retargeting of | Phase I | Colorectal |
| (Macrogenics) | | gpA33 | T cells to | | cancer |
| | | | tumor | | |
| MGD011 | DART | CD19, | | | |
| (Macrogenics) | | CD3 | | | |
| SCORPION | BsAb | CD3, | Retargeting of | | |
| (Emergent | | CD19 | T cells to | | |
| Biosolutions | | | tumor | | |
| Trubion) | | | | | |
| AFM11 (Affimed | TandAb | CD3, | Retargeting of | Phase I | NHL and ALL |
| Therapeutics) | | CD19 | T cells to | | |
| | | | tumor | | |
| AFM12 (Affimed | TandAb | CD19 | Retargeting of | | |
| Therapeutics) | | CD16 | NK cells to | | |
| | | | tumor cells | | |
| AFM13 (Affimed | TandAb | CD30, | Retargeting of | Phase II | Hodgkin's |
| Therapeutics) | | CD16A | NK cells to | | Lymphoma |
| | | | tumor cells | | |
| GD2 (Barbara | T cells | CD3, | Retargeting of | Phase I/II | Neuroblastoma |
| Ann Karmanos | preloaded | GD2 | T cells to | | and |
| Cancer Institute) | with BsAb | | tumor | | osteosarcoma |
| pGD2 (Barbara | T cells | CD3, | Retargeting of | Phase II | Metastatic |
| Ann Karmanos | preloaded | Her2 | T cells to | | breast cancer |
| Cancer Institute) | with BsAb | | tumor | | |
| EGFRBi-armed | T cells | CD3, | Autologous | Phase I | Lung and other |
| autologous | preloaded | EGFR | activated T | | solid tumors |
| activated T cells | with BsAb | | cells to | | |
| (Roger Williams | | | EGFR- | | |
| Medical Center) | | | positive tumor | | |
| Anti-EGFR- | T cells | CD3, | Autologous | Phase I | Colon and |
| armed activated | preloaded | EGFR | activated T | | pancreatic |
| T-cells (Barbara | with BsAb | | cells to | | cancers |
| Ann Karmanos | | | EGFR- | | |
| Cancer Institute) | | | positive tumor | | |
| rM28 (University | Tandem | CD28, | Retargeting of | Phase II | Metastatic |
| Hospital | scFv | MAPG | T cells to | | melanoma |
| Tubingen) | | | tumor | | |
| IMCgp100 | ImmTAC | CD3, | Retargeting of | Phase I/II | Metastatic |
| (Immunocore) | | peptide | T cells to | | melanoma |
| | | MHC | tumor | | |
| DT2219ARL | 2 scFv | CD19, | Targeting of | Phase I | B cell leukemia |
| (NCI, University | linked to | CD22 | protein toxin | | or lymphoma |
| of Minnesota) | diphtheria | | to tumor | | |
| | toxin | | | | |
| XmAb5871 | BsAb | CD19, | | | |
| (Xencor) | | CD32b | | | |
| NI-1701 | BsAb | CD47, | | | |
| (NovImmune) | | CD19 | | | |
| MM-111 | BsAb | ErbB2, | | | |
| (Merrimack) | | ErbB3 | | | |
| MM-141 | BsAb | IGF-1R, | | | |
| (Merrimack) | | ErbB3 | | | |
| NA (Merus) | BsAb | HER2, | | | |
| | | HER3 | | | |
| NA (Merus) | BsAb | CD3, | | | |
| | | CLEC12A | | | |
| NA (Merus) | BsAb | EGFR, | | | |
| | | HER3 | | | |
| NA (Merus) | BsAb | PD1, | | | |
| | | undisclosed | | | |
| NA (Merus) | BsAb | CD3, | | | |
| | | undisclosed | | | |
| Duligotuzumab | DAF | EGFR, | Blockade of 2 | Phase I and II | Head and neck |
| (MEHD7945A, | | HER3 | receptors, | Phase II | cancer |
| Genentech, | | | ADCC | | Colorectal |
| Roche) | | | | | cancer |
| LY3164530 (Eli | Not | EGFR, | Blockade of 2 | Phase I | Advanced or |
| Lily) | disclosed | MET | receptors | | metastatic |
| | | | | | cancer |
| MM-111 | HSA body | HER2, | Blockade of 2 | Phase II | Gastric and |
| (Merrimack | | HER3 | receptors | Phase I | esophageal |
| Pharmaceuticals) | | | | | cancers |
| | | | | | Breast cancer |
| MM-141, | IgG-scFv | IGF-1R, | Blockade of 2 | Phase I | Advanced solid |
| (Merrimack | | HER3 | receptors | | tumors |
| Pharmaceuticals) | | | | | |
| RG7221 | CrossMab | Ang2, | Blockade of 2 | Phase I | Solid tumors |
| (RO5520985, | | VEGF A | proangiogenics | | |
| Roche) | | | | | |
| RG7716 | CrossMab | Ang2, | Blockade of 2 | Phase I | Wet AMD |
| (Roche) | | VEGF A | proangiogenics | | |
| OMP-305B83 | BsAb | DLL4/VEGF | | | |
| (OncoMed) | | | | | |
| TF2 | Dock and | CEA, | Pretargeting | Phase II | Colorectal, |
| (Immunomedics) | lock | HSG | tumor for PET | | breast and lung |
| | | | or | | cancers |
| | | | radioimaging | | |
| ABT-981 | DVD-Ig | IL-1α, IL- | Blockade of 2 | Phase II | Osteoarthritis |
| (AbbVie) | | 1β | proinflammatory | | |
| | | | cytokines | | |
| ABT-122 | DVD-Ig | TNF, IL- | Blockade of 2 | Phase II | Rheumatoid |
| (AbbVie) | | 17A | proinflammatory | | arthritis |
| | | | cytokines | | |
| COVA322 | IgG- | TNF, | Blockade of 2 | Phase I/II | Plaque |
| | fynomer | IL17A | proinflammatory | | psoriasis |
| | | | cytokines | | |
| SAR156597 | Tetravalent | IL-13, IL-4 | Blockade of 2 | Phase I | Idiopathic |
| (Sanofi) | bispecific | | proinflammatory | | pulmonary |
| | tandem | | cytokines | | fibrosis |
| | IgG | | | | |
| GSK2434735 | Dual- | IL-13, IL-4 | Blockade of 2 | Phase I | (Healthy |
| (GSK) | targeting | | proinflammatory | | volunteers) |
| | domain | | cytokines | | |
| Ozoralizumab | Nanobody | TNF, | Blockade of | Phase II | Rheumatoid |
| (ATN103, | | HSA | proinflammatory | | arthritis |
| Ablynx) | | | cytokine, | | |
| | | | binds to HSA | | |
| | | | to increase | | |
| | | | half-life | | |
| ALX-0761 | Nanobody | IL-17A/F, | Blockade of 2 | Phase I | (Healthy |
| (Merck Serono, | | HSA | proinflammatory | | volunteers) |
| Ablynx) | | | cytokines, | | |
| | | | binds to HSA | | |
| | | | to increase | | |
| | | | half-life | | |
| ALX-0061 | Nanobody | IL-6R, | Blockade of | Phase I/II | Rheumatoid |
| (AbbVie, | | HSA | proinflammatory | | arthritis |
| Ablynx; | | | cytokine, | | |
| | | | binds to HSA | | |
| | | | to increase | | |
| | | | half-life | | |
| ALX-0141 | Nanobody | RANKL, | Blockade of | Phase I | Postmenopausal |
| (Ablynx, | | HSA | bone | | bone loss |
| Eddingpharm) | | | resorption, | | |
| | | | binds to HSA | | |
| | | | to increase | | |
| | | | half-life | | |
| RG6013/ACE910 | ART-Ig | Factor | Plasma | Phase II | Hemophilia |
| (Chugai, | | IXa, | coagulation | | |
| Roche) | | factor X | | | |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims.

1. A filter assembly comprising:
a housing defining a hollow interior and an open end;
at least one filter cartridge contained in the hollow interior of the housing, the filter cartridge including a first end and a second end, the second end including at least one gasket that encircles the filter cartridge;
a base attached to the open end of the housing, the base defining a filter receiving recess for receiving the second end of the filter cartridge, the recess including an engaging element for securing the filter cartridge to the base, the recess having a depth and including:
(1) a first section adjacent to a top end of the recess, the first section having a first diameter and a wall, the wall having a tapering height;
(2) a gasket guiding section positioned below the first section, the gasket guiding section comprising a chamfered surface having an angle of from about 30° to about 60° in relation to a vertical line that is parallel to a central axis of the recess; and
(3) a gasket contacting section adjacent to the gasket guiding section, the gasket contacting section having a second diameter that is less than the first diameter, the second diameter having a size that engages the gasket on the filter cartridge to form a fluid tight seal;
a fluid inlet; and
a fluid outlet in communication with the fluid inlet such that fluid flowing into the inlet passes through the at least one filter cartridge to the fluid outlet.

2. A filter assembly as defined in claim 1, wherein the chamfered surface has an angle of from about 35° to about 55°.

3. A filter assembly as defined in claim 1, wherein the chamfered surface has a length of from about 0.8 mm to about 3.2 mm.

4. A filter assembly as defined in claim 1, wherein the chamfered surface has a length of from about 1.1 mm to about 2.6 mm.

5. A filter assembly as defined in claim 1, wherein the wall of the first section has a tapering height such that the difference between a greatest height in the wall and a lowest height in the wall is from about 0.5 mm to about 2 mm.

6. A filter assembly as defined in claim 1, wherein the wall of the first section has a tapering height such that the difference between a greatest height in the wall and a lowest height in the wall is from about 0.8 mm to about 1.5 mm.

7. A filter assembly as defined in claim 1, wherein the wall of the first section has a tapering height such that a top surface of the wall forms an angle of from about 0.5° to about 1.5° in relation to a horizontal line perpendicular to a central axis of the recess.

8. A filter assembly as defined in claim 1, wherein the filter assembly includes a plurality of filter cartridges and a plurality of corresponding filter receiving recesses.

9. A filter assembly as defined in claim 1, wherein the at least one gasket comprises an O-ring.

10. A filter assembly as defined in claim 1, wherein the filter cartridge includes a plurality of locking elements that are secured in a respective plurality of engaging elements on the base within the filter receiving recess.

11. A filter assembly as defined in claim 1, wherein the chamfered surface of the gasket guiding section is positioned adjacent to the first section, and wherein the gasket guiding section has a diameter that is the same as the first diameter at a first end of the chamfered surface and has a diameter that is the same as the second diameter at the second end of the chamfered surface.

12. A filter assembly as defined in claim 1, wherein the filter cartridge comprises a filter media enclosed by a filter housing, the filter media comprising polyvinylidene fluoride.

13. A draining and locking base for a filter assembly comprising:
a base plate having a perimeter;
a securing mechanism for securing the base plate to an open end of a filter housing;
a plurality of filter receiving recesses formed into the base plate, each filter receiving recess for receiving an end of a filter cartridge, each recess including an engaging element for securing the filter cartridge to the base plate, the recess having a depth and including:
(1) a first section adjacent to a top end of the recess, the first section having a first diameter and a wall, the wall having a tapering height;
(2) a gasket guiding section positioned below the first section, the gasket guiding section comprising a chamfered surface having an angle of from about 30° to about 60° in relation to a vertical line that is parallel to a central axis of the recess; and
(3) a gasket contacting section adjacent to the gasket guiding section, the gasket contacting section having a second diameter that is less than the first diameter, the second diameter having a size that engages a gasket on a filter cartridge installed in the recess.

14. A draining and locking base as defined in claim 13, wherein the base plate defines at least one fluid outlet and wherein each of the filter receiving recesses are in fluid communication with one of the outlets.

15. A draining and locking base as defined in claim 13, wherein the chamfered surface has an angle of from about 35° to about 55°.

16. A draining and locking base as defined in claim 13, wherein the chamfered surface has a length of from about 0.8 mm to about 3.2 mm.

17. A draining and locking base as defined in claim 13, wherein the chamfered surface has a length of from about 1.1 mm to about 2.6 mm.

18. A draining and locking base as defined in claim 13, wherein the wall of the first section has a tapering height such that the difference between a greatest height in the wall and a lowest height in the wall is from about 0.5 mm to about 2 mm.

19. A draining and locking base as defined in claim 13, wherein the wall of the first section has a tapering height such that the difference between a greatest height in the wall and a lowest height in the wall is from about 0.8 mm to about 1.5 mm.

20. A draining and locking base as defined in claim 13, wherein the chamfered surface of the gasket guiding section is positioned adjacent to the first section, and wherein the gasket guiding section has a diameter that is the same as the first diameter at a first end of the chamfered surface and has a diameter that is the same as the second diameter at the second end of the chamfered surface.
